(19) United States
(12) Patent Application Publication
(10) Pub. No.: US 2025/0132358 A1
(43) Pub. Date: Apr. 24, 2025

(54) FUEL CELL AFTERBURNER HAVING AT LEAST ONE FLOW PATH CONTROL PARTITION UNIT INSIDE STACKED CHAMBERS AND FUEL CELL HOTBOX INCLUDING THE SAME

(71) Applicant: UIF (University Industry Foundation), Yonsei University, Seoul (KR)

(72) Inventors: Jongsup Hong, Seoul (KR); Dongyoung Yoon, Seoul (KR); Hoyun Choi, Seoul (KR)

(21) Appl. No.: 18/906,533

(22) Filed: Oct. 4, 2024

(30) Foreign Application Priority Data
Oct. 18, 2023 (KR) 10-2023-0139247

(51) Int. Cl. H01M 8/04014; H01M 8/04746; H01M 8/12

(52) U.S. Cl. CPC H01M 8/04022; H01M 8/04761; H01M 8/12; H01M 2008/1293

(57) ABSTRACT

Disclosed herein is a fuel cell afterburner having at least one flow path control partition unit inside stacked chambers. The fuel cell afterburner includes: a lower bypass chamber configured such that the cathode exhaust gas introduced from a first open end flows out and the anode exhaust gas introduced from one side is separated from the cathode exhaust gas and flows out; a combustion chamber configured such that the cathode exhaust gas introduced from a first open end and the anode exhaust gas introduced through an internal inlet are mixed and combusted and then moved to a second open end; and an upper bypass chamber configured such that the cathode exhaust gas introduced from a first open end flows out and the anode exhaust gas moving upward from the internal inlet of the combustion chamber does not enter the internal space of the upper bypass chamber.

### CROSS-REFERENCE TO RELATED APPLICATION

This application claims the benefit of Korean Patent Application No. 10-2023-0139247 filed on Oct. 18, 2023, which is hereby incorporated by reference herein in its entirety.

### BACKGROUND

### 1. Technical Field

The present invention relates to a fuel cell afterburner and a fuel cell hotbox. More particularly, the present invention relates to a fuel cell afterburner having at least one flow path control partition unit inside stacked chambers and a fuel cell hotbox including the afterburner.

### 2. Description of the Related Art

A solid oxide fuel cell (SOFC) that operates at a high temperature of 700° C. or higher is a fuel cell that uses a solid oxide (ceramic) having oxygen ion conductivity as an electrolyte, and can use various hydrocarbon fuels such as natural gas, LPG, propane and butane, and biofuels, in addition to hydrogen, as its fuel.

An SOFC power generation system includes Balance of Plant (BOP) systems such as a power conversion device, a blower and pump for supplying reactants, a heat recovery system, and a control system in addition to fuel cell stacks. Accordingly, in order to improve the efficiency of the SOFC power generation system, it is significantly important to design the system for the purpose of insulation and heat management, as well as to improve the performance of system components such as stacks, a fuel reformer, and a power converter.

In the SOFC power generation system, heat is generated in the fuel cell stacks, an afterburner, and a heating reformer. In contrast, heat is required in a steam reformer, a vaporizer, an air preheater, a fuel preheater, and a hot water production device. Accordingly, calculating the amounts of heat generated and required in the system, designing a heat exchange network appropriately, and minimizing heat loss considerably affect the overall efficiency of the SOFC system. In order to efficiently manage the heat of the SOFC system, it is important to supply an amount of heat equal to the amount required for maintaining the temperature of the stack, preheating fuel, and reforming fuel by using the heat generated in the stack during operation and the heat obtained by combusting unreacted fuel.

In order to operate a fuel cell hotbox stably, there is required a hotbox structure for forming operating conditions that can alleviate internal heat/chemical distribution. In order to form the desired operating conditions, a sufficient heat source is required, and an effective afterburner is required to supply such a heat source.

A first problem of a conventional afterburner is the low fuel ratio of fuel gas. The fuel ratio is too low for natural ignition/combustion to occur due to the high fuel utilization rate and low air utilization rate. To overcome this problem, combustion using a catalyst or the adjustment of the equivalence ratio through the branching of rear-end air is required.

A second problem of the conventional afterburner is the generation of high temperature attributable to combustion. Combustion occurs locally, and thus a high temperature of 1300° C. or higher is generated, which may damage structural safety. Therefore, it is necessary to decrease the maximum temperature by using an effective heat dissipation/cooling structure.

### RELATED ART LITERATURE

Patent document 1: Korean Patent No. 10-2336581 (published on Dec. 2, 2021)
Patent document 2: Korean Patent No. 10-2387372 (published on Apr. 12, 2022)

### SUMMARY

A fuel cell afterburner having at least one flow path control partition unit inside stacked and coupled chambers and a fuel cell hotbox including the afterburner according to the present invention have the following objects:

A first object is to control the amount of oxidant supplied to a combustion chamber.

A second object is to allow the mixing of fuel and an oxidant inside the combustion chamber to be performed smoothly.

A third object is to prevent the excessive heating of the combustion chamber.

A fourth object is to form and control the flow resistance of gas inside each chamber.

The objects of the present invention are not limited to those mentioned above, and other objects not mentioned may be clearly understood by those skilled in the art from the following description.

According to an aspect of the present invention, there is provided a fuel cell afterburner having at least one flow path control partition unit inside stacked chambers, the fuel cell afterburner including: a lower bypass chamber configured such that the cathode exhaust gas introduced from a first open end flows out into a second open end, and provided with a transverse flow path through which the anode exhaust gas introduced from one side is separated from the cathode exhaust gas and flows out into a combustion chamber coupled to the top side of the lower bypass chamber; the combustion chamber coupled to the top side of the lower bypass chamber, and configured such that the cathode exhaust gas introduced from a first open end and the anode exhaust gas introduced through an internal inlet communicating with the transverse flow path of the lower bypass chamber are mixed and combusted and then moved to a second open end; and an upper bypass chamber coupled to the top of the combustion chamber, configured such that the cathode exhaust gas introduced from a first open end flows out into a second open end, and provided with a longitudinal flow path that is closed such that the anode exhaust gas moving upward from the internal inlet of the combustion chamber without entering the combustion chamber does not enter the internal space of the upper bypass chamber; wherein at least one of internal spaces of the lower bypass chamber, the combustion chamber, and the upper bypass chamber is provided with a flow path control partition unit in which a plurality of partitions are arranged to be spaced apart from each other.

The internal inlet of the combustion chamber may be provided with one or more partitions that prevent the introduced anode exhaust gas from moving directly in the direction of the second open end.

The amount of anode exhaust gas flowing in into the combustion chamber may be controlled by adjusting the flow resistance of each of the chambers using the flow path control partition unit.

The excessive heating of the combustion chamber may be prevented in such a manner that the lower and upper bypass chambers absorb the heat generated in the combustion chamber.

The flow path control partition unit may be provided in a structure in which the plurality of partitions spaced apart from each other are arranged vertically or obliquely to the direction in which the introduced gas moves.

The vertical or oblique arrangement structure of the plurality of partitions in the flow path control partition unit may be configured such that a partition arrangement configured to branch each gas and a partition arrangement configured to merge individual gases are repeated.

The flow path control partition unit may have a fixed partition structure in which the plurality of partitions are fixedly arranged.

The flow path control partition unit may have a laterally variable partition structure in which the plurality of partitions are provided to be rotatable laterally within a preset angular range and, thus, can control the space through which gas moves.

The pivot points of the individual partitions of the individual chambers that are vertically stacked on top of each other may be coupled to respective lateral rotation shafts that are arranged to vertically pass through the individual chambers, so that, when the lateral rotation shafts are rotated laterally, the individual partitions are also rotated laterally.

The flow path control partition unit may have a bimetallic partition structure in which the plurality of partitions are made of a bimetallic material and, thus, can be bent laterally at a preset temperature.

Each of the plurality of partitions of the flow path control partition unit may include at least one of: a closed partition in which a height of the partition is provided to be coupled to both bottom and top surfaces of the internal space; and a partially open partition in which a height of the partition is coupled to a bottom surface of the internal space and separated from a top surface of the internal space, or is coupled to the bottom surface of the internal space and separated from the top surface of the internal space, so that gas can move through a space over or under the partition.

The flow path control partition unit may have a vertically variable partition structure in which the plurality of partitions are provided to be rotatable vertically within a preset angular range and, thus, can control the space through which gas moves.

The individual partitions in contact with the inner wall of each of the chambers may be coupled to vertical rotation shafts that are vertically arranged to laterally pass through the chamber from the outside of the chamber, so that, when the vertical rotation shafts are vertically rotated from the inside or outside of the chamber, the individual partitions are also rotated vertically.

Two-chamber combinations of a combustion chamber and an upper bypass chamber may repeatedly be stacked on top of the lower bypass chamber, the combustion chamber, and the upper bypass chamber sequentially stacked on top of each other.

Two-chamber combinations of a combustion chamber and an upper bypass chamber may repeatedly be stacked on top of the lower bypass chamber, the combustion chamber, and the upper bypass chamber sequentially stacked on top of each other.

The lower bypass chamber may be provided on the lowest side, the upper bypass chamber may be provided on the highest side, and a plurality of combustion chambers may repeatedly be stacked therebetween.

According to another aspect of the present invention, there is provided a fuel cell hotbox, including: a housing provided with a first internal space, a first inlet, a second inlet, and an outlet; a central chamber part located in the center of the first internal space, and provided with a second internal space, an afterburner, and a reformer; a plurality of fuel cell stack parts located at equal distances from the center of the central chamber part in the first internal space, and arranged at regular intervals therebetween; and an air-heat exchange part provided between the plurality of fuel cell stack parts and the central chamber part; wherein the afterburner includes: a lower bypass chamber configured such that the cathode exhaust gas introduced from a first open end flows out into a second open end, and provided with a transverse flow path through which the anode exhaust gas introduced from one side is separated from the cathode exhaust gas and flows out into a combustion chamber coupled to the top side of the lower bypass chamber; the combustion chamber coupled to the top side of the lower bypass chamber, and configured such that the cathode exhaust gas introduced from a first open end and the anode exhaust gas introduced through an internal inlet communicating with the transverse flow path of the lower bypass chamber are mixed and combusted and then moved to a second open end; and an upper bypass chamber coupled to the top of the combustion chamber, configured such that the cathode exhaust gas introduced from a first open end flows out into a second open end, and provided with a longitudinal flow path that is closed such that the anode exhaust gas moving upward from the internal inlet of the combustion chamber without entering the combustion chamber does not enter the internal space of the upper bypass chamber; wherein at least one of internal spaces of the lower bypass chamber, the combustion chamber, and the upper bypass chamber is provided with a flow path control partition unit in which a plurality of partitions are arranged to be spaced apart from each other.

The fuel cell afterburner having the one or more flow path control partition units inside the stacked and coupled chambers and the fuel cell hotbox including the afterburner according to the present invention have the following effects: First, there is an effect in that the amount of oxidant supplied to the combustion chamber is controlled using the upper and lower bypass chambers.

Second, there is an effect in that the mixing of fuel and an oxidant inside the combustion chamber is performed smoothly through the internal inlet, inflow direction control part, and partition structure of the combustion chamber.

Third, there is an effect in that the excessive heating of the combustion chamber is prevented in such a manner that the lower and upper bypass chambers absorb the heat generated in the combustion chamber.

Fourth, there is an effect in that one or more flow path control partition units are provided, e flow resistance of gas inside each chamber is formed and controlled. More specifically, there is an effect in that the individual partitions of the flow path control partition units are provided in fixed, variable, and/or bimetallic forms and the flow resistance of gas is controlled by rotating each partition laterally, adjusting a difference in the height of each partition, or rotating each partition vertically.

The effects of the present invention are not limited to those mentioned above, and other effects not mentioned may be clearly understood by those skilled in the art from the following description.

### BRIEF DESCRIPTION OF THE DRAWINGS

The above and other objects, features, and advantages of the present invention will be more clearly understood from the following detailed description taken in conjunction with the accompanying drawings, in which:

FIG. 1 shows the schematic configuration of a fuel cell hotbox according to an embodiment of the present invention;

FIG. 2 shows a side of the fuel cell hotbox according to the embodiment of the present invention;

FIG. 3 shows the flow paths of the fuel introduced into the fuel cell hotbox according to the embodiment of the present invention;

FIG. 4 shows the flow paths of the air introduced into the fuel cell hotbox according to the embodiment of the present invention;

FIG. 5 shows the flow paths of the combustion gas generated in the fuel cell hotbox according to the embodiment of the present invention;

FIG. 6(a) is a half-sectional view showing the shape of ¼ of the fuel cell hotbox according to the embodiment of the present invention, and FIG. 6(b) shows the flow paths of fuel, air, and combustion gas;

FIG. 7 is a flow diagram showing the flow paths of fuel, air, and combustion gas according to an embodiment of the present invention;

FIGS. 8 and 9 are sectional views of a fuel cell afterburner according to the present invention;

FIG. 10(a) shows an embodiment of a lower bypass chamber equipped with a transverse flow path, FIGS. 10(b) and 10(c) show embodiments of combustion chambers equipped with different internal inflow paths, and FIG. 10(d) is an embodiment of an upper bypass chamber equipped with a longitudinal flow path;

FIG. 11 shows a sectional plan view of a fuel cell hotbox according to an embodiment of the present invention and a sectional front view taken along line A-A of the sectional plan view;

FIG. 12 shows a sectional plan view of a fuel cell hotbox according to an embodiment of the present invention and a sectional front view taken along line B-B of the sectional plan view;

FIG. 13 shows an embodiment in which a lower bypass chamber, a combustion chamber, and an upper bypass chamber are stacked on top of each other and coupled to each other in an afterburner according to the present invention;

FIG. 14 shows an embodiment of gas flows inside the individual chambers of FIG. 13;

FIG. 15 is a conceptual diagram of an embodiment in which individual chambers are stacked on top of each other and coupled to each other in an afterburner according to the present invention;

FIG. 16 shows diagrams of combustion chambers, wherein FIG. 16(a) shows a situation in which the flow resistance of the anode exhaust gas introduced through an anode exhaust gas internal inlet and the flow resistance of the cathode exhaust gas introduced through a first open end are controlled by partitions, and FIGS. 16(b) and 16(c) show other embodiments of the anode exhaust gas internal inlet;

FIG. 17 is a conceptual diagram showing controllable variables in FIG. 16;

FIG. 18(a) shows an embodiment in which partitions are arranged vertically to the direction in which gas moves, and shows an embodiment in which partitions are FIG. 18(b) arranged obliquely to the direction in which gas moves;

FIG. 19(a) shows an embodiment of a closed partition in which the height of the partition is provided to be coupled to both the bottom and top surfaces of the internal space, FIG. 19(b) shows an embodiment of a partially open partition in which the height of the partition is provided to be coupled to the bottom surface of the internal space but is separated from the top surface of the internal space, so that gas can move over the partition, and FIG. 19(c) shows an embodiment in which closed partitions and partially open partitions are provided together and the partially open partitions are provided within the channels formed by the closed partitions;

FIG. 20(a) shows an embodiment in which partitions are fixed, FIG. 20(b) shows an embodiment in which partitions are rotatable about transverse rotation shafts as rotation axes, and FIG. 20(c) shows an embodiment of a bimetallic partition structure in which partitions are made of a bimetallic material and, thus, can be bent laterally based on pivot points at a preset temperature;

FIG. 21 shows an embodiment in which partitions are rotatable about vertical rotation shafts; and

FIGS. 22(a) to 22(c) show various embodiments of the repeated stack coupling of individual chambers according to the present invention.

### DETAILED DESCRIPTION

Embodiments of the present invention will be described with reference to the accompanying drawings below such that those having ordinary skill in the art to which the present invention pertains can easily implement the invention. As can be easily understood by those having ordinary skill in the art to which the present invention pertains, the embodiments to be described below may be modified in various forms without departing from the spirit and scope of the present invention. Identical or similar parts will be denoted by the same reference numerals throughout the drawings as much as possible.

The terminology used herein is intended merely to describe specific embodiments, but is not intended to limit the invention. The singular forms used herein include plural forms as well, unless the phrases clearly indicate the contrary.

The terms “include,” “including,” and their derivatives used herein each specify one or more particular features, regions, integers, steps, operations, elements, and/or components, but do not exclude the presence or addition of one or more other particular features, regions, integers, steps, operations, elements, components, and/or combinations thereof. All the terms, including technical and scientific terms, used herein have the same meanings as commonly understood by those having ordinary skill in the art to which the present invention pertains. The terms defined in the dictionaries may be additionally interpreted as having meanings consistent with the relevant technical literature and the present disclosure, and should not be construed in an ideal or excessively formal sense unless otherwise defined.

The terms regarding directions used herein, such as terms including front/back/left/right, terms including up/down, and terms including vertical/lateral, may be interpreted with reference to the directions disclosed in the accompanying drawings.

The components described as “rib” in the accompanying drawings refer to “partitions.”

The present invention may be implemented as an invention regarding a fuel cell afterburner having at least one flow path control partition unit inside stacked chambers and an invention regarding a fuel cell hotbox including the afterburner. It should be noted that the afterburner according to the present invention is not limited to the hotbox structure according to the present invention, but may be combined with hotboxes having different structures. For example, the afterburner may be placed on top of a stack part, but is not limited to that location.

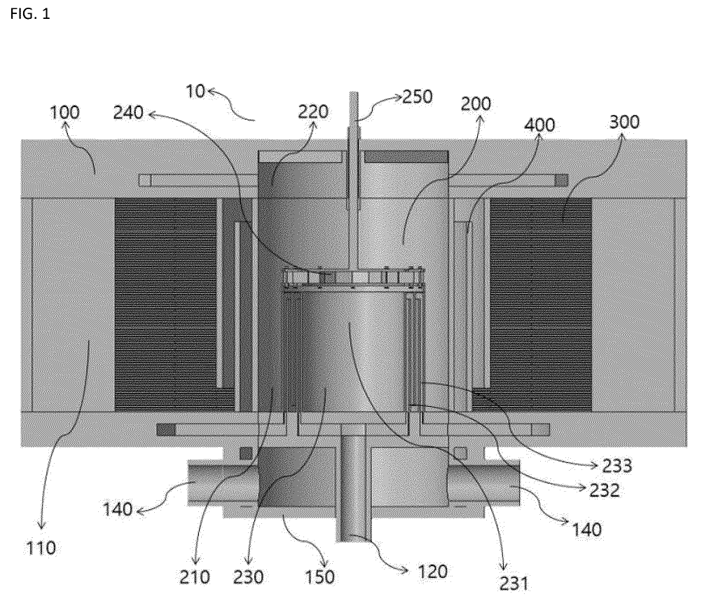

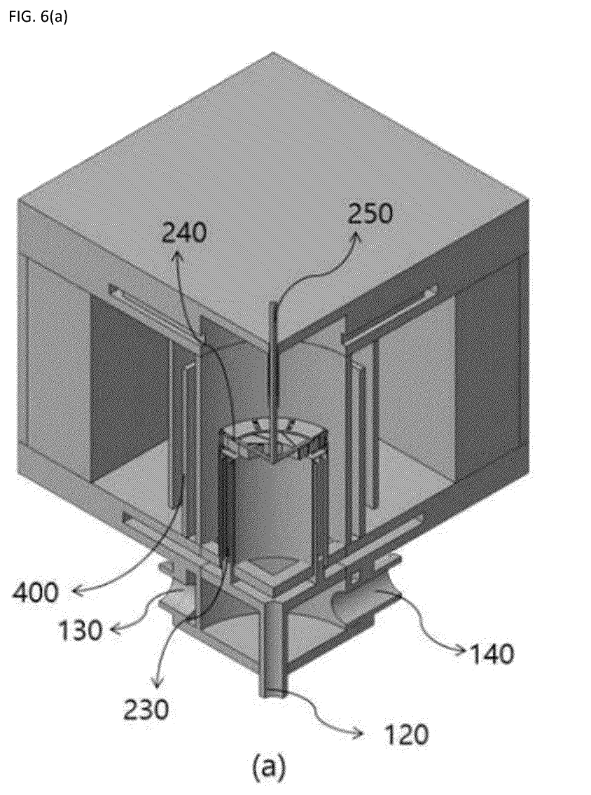

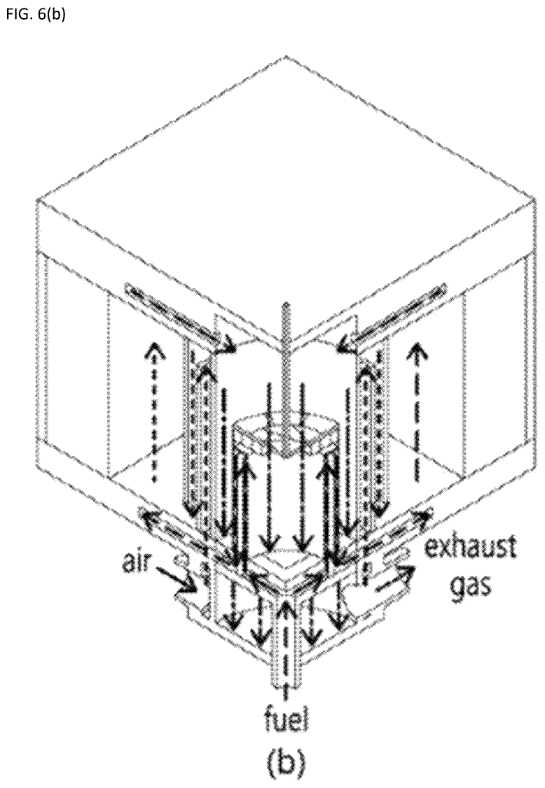

In order to facilitate the description of the present invention, the general configuration of the invention regarding a fuel cell hotbox will first be described with reference to FIGS. 1 to 7, and then the technical features of the invention regarding a fuel cell afterburner according to the present invention will be described.

The present invention will be described with reference to the accompanying drawings below. For reference, the drawings may be partially exaggerated to illustrate the features of the present invention. In this case, it is preferable to interpret them in light of the overall purport of the present specification.

FIGS. 1 to 7 illustrate the configuration of a fuel cell hotbox 10 according to an embodiment of the present invention. The present invention will be described in more detail below with reference to the accompanying drawings in order to help to understand the present invention. However, the following embodiments are provided merely to help to understand the present invention more easily, and the content of the present invention is not limited to the following embodiments.

FIG. 1 schematically shows the configuration of the fuel cell hotbox 10 according to the embodiment of the present invention. Referring to FIG. 1, the fuel cell hotbox 10 according to the present embodiment includes a housing 100, a central chamber part 200, fuel cell stack parts 300, and an air-heat exchange part 400.

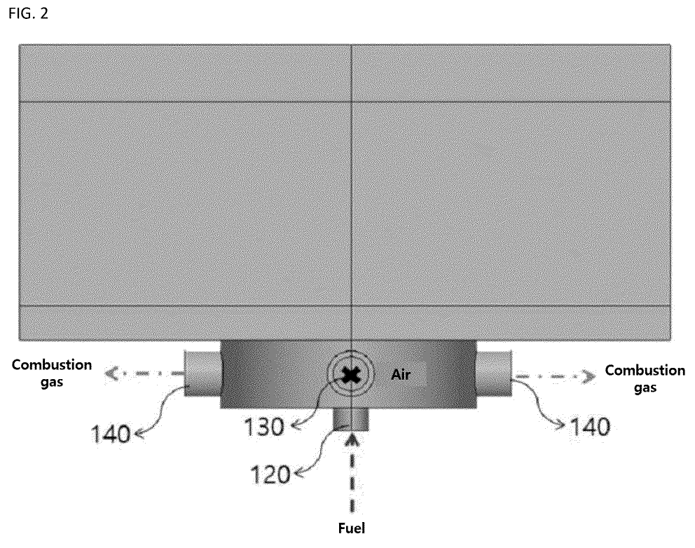

The housing 100 may be formed in a rectangular hexahedron shape. However, it is not limited thereto, and may be formed in various shapes such as a square hexahedron, an oblong hexahedron, a cylinder, etc. As shown in FIGS. 1 and 2, a first internal space 110, a first inlet 120, a second inlet 130, and an outlet 140 may be formed in the housing 100. An insulation layer may be formed on the inner surface of the housing 100. The insulation layer may be made of a heat-resistant material in order to prevent damage attributable to high temperature.

As a specific embodiment, the first inlet 120, the second inlet 130, and the outlet 140 may be formed in a flow chamber 150 formed in a stepped shape on the bottom surface of the housing 100. The flow chamber 150 is a space in which the inlet gas and air introduced through the first inlet 120 and the second inlet 130 can exchange heat with the combustion gas flowing out through the outlet 140, and may be formed in various shapes such as a circle, a square, etc. having a size smaller than the bottom surface of the housing 100.

The first internal space 110 is a space defined by the inner side of the housing 100, accommodates the central chamber part 200, the stack parts 300 and the air-heat exchange part 400, and provides a space in which the unreacted air and unreacted fuel passing through the stack parts 300 can move to the inlet (not shown) of an afterburner 220. The first internal space 110 may be formed in various manners depending on the shape and arrangement of the central chamber part 200, the fuel cell stack parts 300, and the air-heat exchange part 400. The first internal space 110 may be formed as, for example, but is not limited to, a hexahedral space. The first inlet 120 may be formed in the flow chamber 150 formed on the bottom surface of the housing 100, and is connected to the reforming part 232 of a reformer 230 to communicate with the outside of the housing 100. The first inlet 120 is a place through which the fuel used in the fuel cell is introduced, and the fuel may include methane, gasoline, biogas, methanol, ethanol, etc. in addition to hydrogen.

The first inlet 120 may include a plurality of first inlets 120 depending on the number, capacity, and arrangement of fuel cell stack parts 300, in which case the first inlets 120 may be provided in different shapes and sizes. A fuel supply device for effectively injecting fuel may be connected to the first inlet 120.

The second inlet 130 may be formed in the flow chamber 150 formed on the bottom surface of the housing 100, and is connected to the air-heat exchange part 400 to communicate with the outside of the housing 100. The second inlet 130 is a place through which the air used in the fuel cell is introduced. The second inlet 130 may include a plurality of second inlets 130 depending on the number and capacity of fuel cell stack parts, in which case the second inlets 130 may be connected to respective air supply devices to effectively inject air.

The outlet 140 may be formed in the flow chamber 150 formed on the bottom surface of the housing 100, and is connected to allow the outside of the housing 100 to communicate with a second internal space 210 and a through hole 231. The second internal space 210 is a space inside the central chamber part 200 excluding the reformer 230 and the afterburner 220 in which the through hole 231 is formed, and the outlet 140 helps the combustion gas generated in the afterburner 220 pass through the second internal space 210 and the through hole 231 and be discharged out of the housing 100. The outlet 140 may include a plurality of outlets 140 depending on the number and capacity of stack parts 300 and the capacity of the afterburner 220, in which case the outlets 140 may be connected to respective combustion gas discharge devices to effectively discharge combustion gas. The second inlet 130 and the outlet 140 may be located near each other or opposite each other in the flow chamber 150.

As one specific embodiment, as shown in FIGS. 1 and 2, a plurality of outlets 140 may be formed through the side surfaces of the flow chamber 150 to face each other with the flow chamber 150 disposed therebetween, and a plurality of second inlets 130 may be formed through the side surfaces of the flow chamber 150 in the directions perpendicular to the directions in which the outlets 140 are formed.

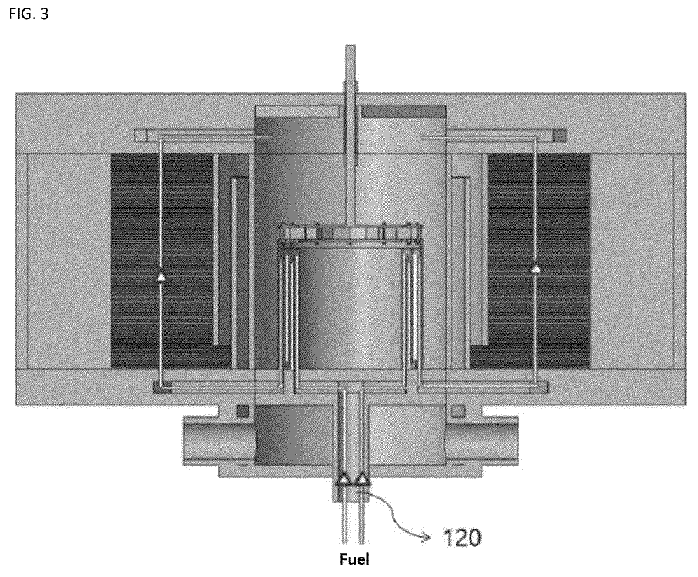

As another specific embodiment, as shown in FIG. 3, the first inlet 120 may be formed through the bottom surface of the flow chamber 150. The fuel introduced into the first inlet 120 passes through the reformer 230 and flows into the fuel cell stack parts 300, and the fuel having passed through the fuel cell stack parts 300 flows into the afterburner 220 and is combusted together with air.

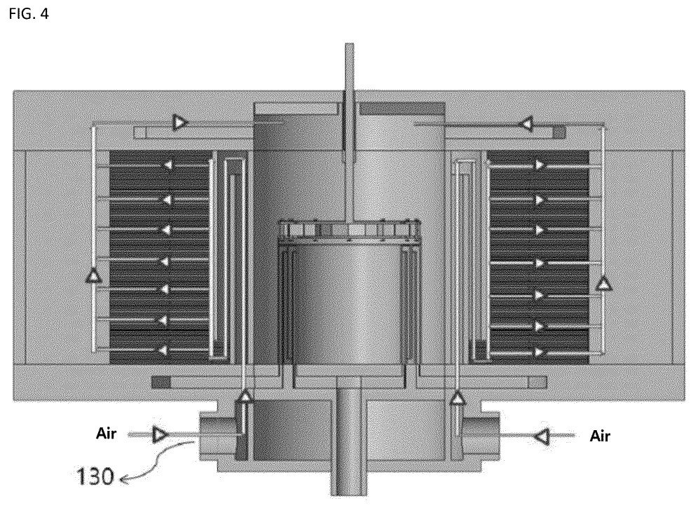

As still another specific embodiment, as shown in FIGS. 4 to 6, the plurality of second inlets 130 may be formed to face each other with the flow chamber 150 interposed therebetween, and the plurality of outlets 140 may also be formed to face each other with the flow chamber 150 interposed therebetween. The air introduced into the second inlet 130 passes through the air-heat exchange part 400 and flows into the fuel cell stack parts 300, and passes through the fuel cell stack parts 300 and flows into the afterburner 220.

When fuel and air are combusted in the afterburner 220 and combustion gas is generated, the combustion gas is discharged to the second internal space 210, and part of the combustion gas passes through the reformer 230, passes through the flow chamber 150 and flows out of the housing 100 through the outlet 140 and the remaining part thereof flows out of the housing 100 directly through the outlet 140.

The central chamber part 200 is located in the center of the first internal space 110, and the plurality of fuel cell stack parts 300 are arranged around the central chamber part 200. The central chamber part 200 may be formed in various shapes and sizes depending on the capacity, size, and arrangement of the plurality of fuel cell stack parts 300. The central chamber part 200 may be formed in, for example, but is not limited to, a cylindrical shape. Furthermore, the central chamber part 200 separates the air and fuel introduced into the housing 100, so that the air is preheated outside the central chamber part 200 and the fuel is preheated and reformed inside the central chamber part 200. The preheated and reformed fuel moves from the central chamber part 200 to the plurality of fuel cell stack parts 300. That is, the plurality of fuel cell stack parts 300 may share the central chamber part 200 and receive evenly distributed reformed fuel.

In this manner, the plurality of fuel cell stack parts 300 share the central chamber part 200, so that the overall configuration of the fuel cell hotbox 10 can be simplified. Furthermore, the central chamber part 200 exchanges heat with the air-heat exchange part 400. The sides of the central chamber part 200 may be made of, but is not limited thereto, a material including a metal having high thermal conductivity and heat resistance for the purpose of heat exchange with the air-heat exchange part 400. Furthermore, the central chamber part 200 is connected to the first inlet 120 and the outlets 140. Therefore, the fuel introduced into the housing 100 may flow into the reformer 230 inside the central chamber part 200 through the first inlet 120, and the combustion gas generated in the central chamber part 200 may be discharged out of the housing 100 through the outlets 140. The central chamber 200 includes the second internal space 210, the afterburner 220, and the reformer 230 in one space, so that the heat of the combustion gas generated in the afterburner 220 can be used to promote the preheating and reforming of fuel in the reformer 230.

The second internal space 210 is a space inside the central chamber part 200 excluding the afterburner 220 and the reformer 230, and is filled with high-temperature combustion gas discharged from the afterburner 220 while the fuel cell is in operation. Accordingly, the combustion gas of the second internal space 210 may exchange heat with the air-heat exchange part 400 through the side walls of the central chamber part 200, and may also exchange heat with the reformer 230. As described above, the second internal space 210 may be connected to the outlets 140 so that the combustion gas can be discharged out of the housing 100.

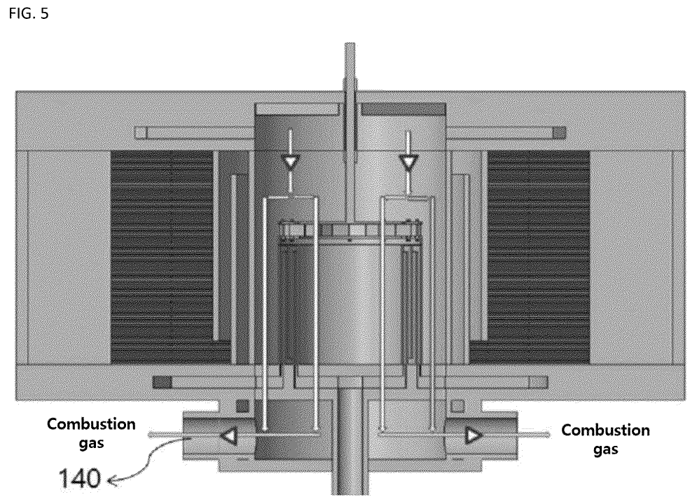

FIG. 5 show the schematic configuration of a fuel cell hotbox according to a specific embodiment of the present invention and the flow paths of the combustion gas generated in the afterburner 220. Referring to FIG. 5, the afterburner 220 may be provided on one side of the vertical central axis of the central chamber part 200, and the reformer 230 may be provided on the other side of the vertical central axis. The afterburner 220 may be provided on, but is not limited to, the upper side of of the vertical central axis of the central chamber part 200, which is one side of the vertical central axis of the central chamber part 200.

A first open end 220a, which is the side of the afterburner 220, communicates with the plurality of stack parts 300 through the first internal space 110, and the unreacted air having passed through the fuel cell stack parts 300 is introduced into the first open end 220a, which is the side of the afterburner 220, through the first internal space 110. The unreacted fuel having passed through the fuel cell stack parts 300 is introduced into the afterburner 220 through a duct that connects a portion over the fuel cell stack parts 300 with the side of the afterburner 220. In this case, the concentration of fuel components in the unreacted fuel and air is low due to large amounts of CO₂ and H₂O generated in the fuel cell stack parts 300, so that there are cases where it is difficult to perform complete combustion using a general combustion method. To overcome this problem, a combustion catalyst made of a precious metal such as Pt or Ir may be used to promote the complete combustion of fuel. High-temperature combustion gas is generated while the introduced fuel and air are combusted inside the afterburner 220.

The generated high-temperature combustion gas is discharged to the second internal space 210 through a second open end 220b, which is the other side of the afterburner 200, promotes the preheating and reforming of fuel and the preheating of air, and is then discharged out of the housing 100 through the outlets 140 of the housing. The afterburner 220 may be equipped with a device for guiding the generated high-temperature combustion gas through discharge into the second internal space 210.

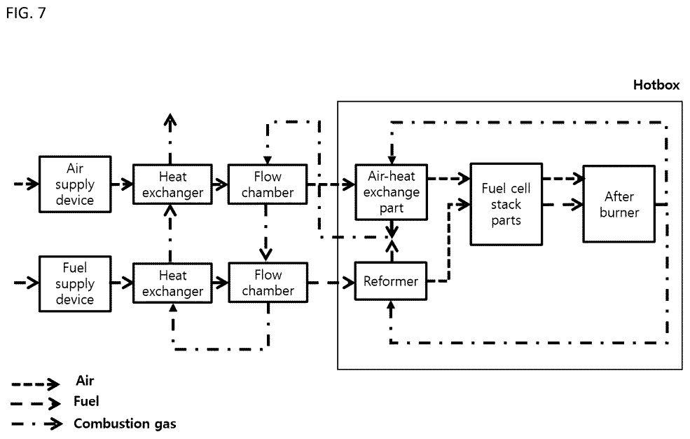

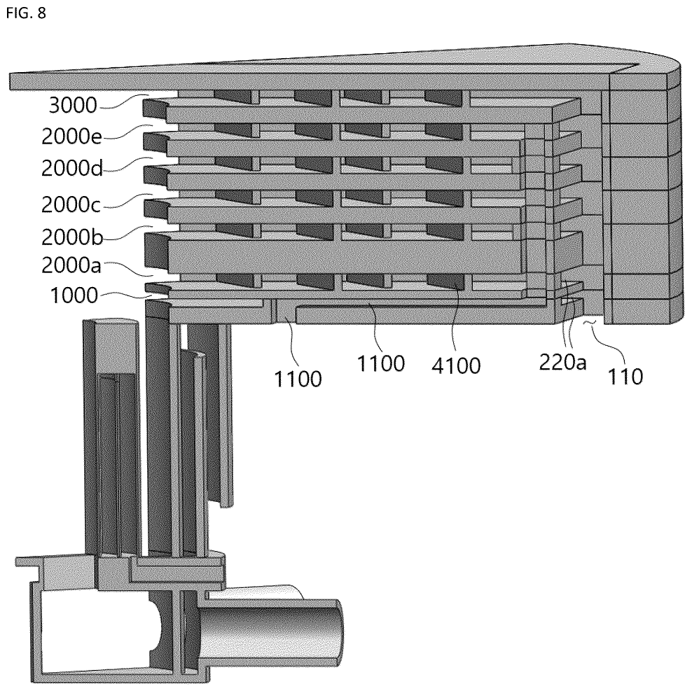

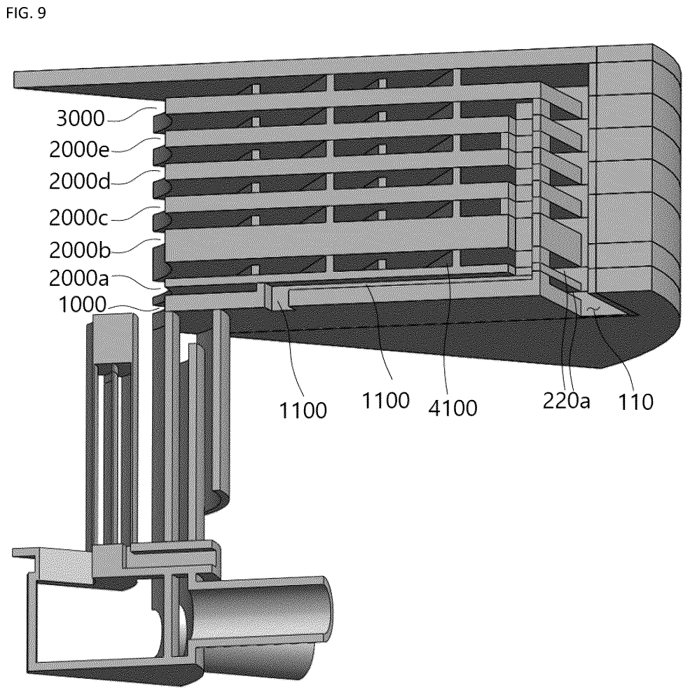

FIG. 7 is a flow diagram showing the flow paths of fuel, air, and combustion gas according to an embodiment of the present invention. Referring to FIG. 7, when air is primarily preheated through the heat exchanger outside the fuel cell hotbox by the air supply device and is then introduced into the flow chamber 150 through the second inlet 130, it is secondarily preheated by the heat of the high-temperature combustion gas discharged from the afterburner 220.

Thereafter, it is tertiarily preheated by the heat of the high-temperature fuel cell stack parts and the high-temperature combustion gas while passing through the air-heat exchanger, and flows into the fuel cell stack parts 300. When fuel is primarily preheated through the heat exchanger outside the fuel cell hotbox by the fuel supply device and is then introduced into the flow chamber 150 through the first inlet 120, it is secondarily preheated by the heat of the combustion gas discharged from the afterburner 220. Thereafter, it may be tertiarily preheated by the heat of the high-temperature combustion gas while passing through the reforming part 232 of the reformer 230 and the fuel-heat exchange part 233. In this case, the fuel is reformed, and becomes a resource that can be used in the fuel cell stack parts 300. The air and reformed fuel introduced into the fuel cell stack parts 300 react with each other to produce water, electricity and heat, and unreacted air and unreacted fuel pass through the fuel cell stack parts 300 and flow into the afterburner 220. The introduced unreacted air and fuel undergo a combustion reaction and generate high-temperature combustion gas, and the high-temperature combustion gas is distributed to the reformer 230 and its surroundings, preheats fuel and air, and then preheats fuel and air until it passes through the flow chamber 150 and then flows out into the outlets 140. In this manner, the combustion gas of the afterburner is not discharged directly out of the housing 100, but air and fuel is preheated using the heat of the combustion gas a plurality of times, so that the efficiency of the overall system can be improved.

Next, the fuel cell afterburner according to the present invention will be described.

The afterburner 220 according to the present invention is formed by stacking and coupling a lower bypass chamber 1000, at least one combustion chamber 2000, and an upper bypass chamber 3000.

More specifically, the present invention provides a fuel cell afterburner having at least one flow path control partition unit inside stacked chambers, the fuel cell afterburner including:

the lower bypass chamber 1000 configured such that the cathode exhaust gas (air; an oxidant) introduced from the first open end 220a (which communicates with the first internal space 110) flows out into the second open end 220b (which communicates with the second internal space 220), and provided with a transverse flow path 1100 through which the anode exhaust gas (fuel) introduced from one side is separated from the cathode exhaust gas (air; the oxidant) and flows out into the combustion chamber 2000 coupled to the top side of the lower bypass chamber 1000;

the combustion chamber 2000 coupled to the top side of the lower bypass chamber 1000, and configured such that the cathode exhaust gas (air; an oxidant) introduced from the first open end 220a and the anode exhaust gas (fuel) introduced through an internal inlet 2100 communicating with the transverse flow path 1100 of the lower bypass chamber 1000 are mixed and combusted and then moved to the second open end 220b; and

the upper bypass chamber 3000 coupled to the top of the combustion chamber 2000, configured such that the cathode exhaust gas (air; an oxidant) introduced from the first open end 220a flows out into the second open end 220b, and provided with a longitudinal flow path 3100 that is closed such that the anode exhaust gas (fuel) moving upward from the internal inlet 2100 of the combustion chamber without entering the combustion chamber does not enter the internal space of the upper bypass chamber 3000;

wherein at least one of the internal spaces of the lower bypass chamber 1000, the combustion chamber 2000, and the upper bypass chamber 3000 is provided with a flow path control partition unit in which a plurality of partitions 4100 are arranged to be spaced apart from each other.

In the case of the stacked chambers of the afterburner, the lower and upper parts of the afterburner may be provided as bypass chambers. The lower bypass chamber 1000 has the transverse flow path 1100 configured to supply anode exhaust gas to the combustion chamber, and the anode exhaust gas may be separated from cathode exhaust gas.

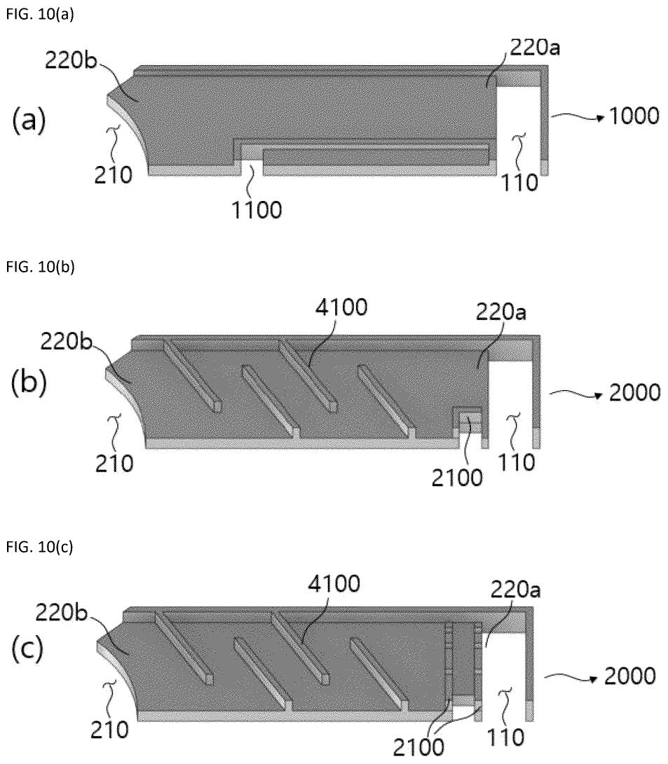

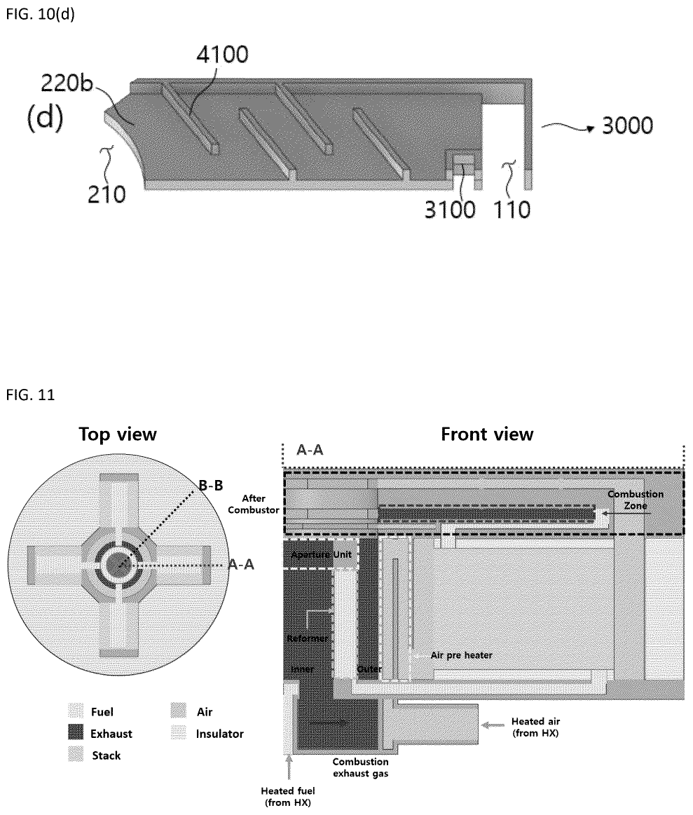

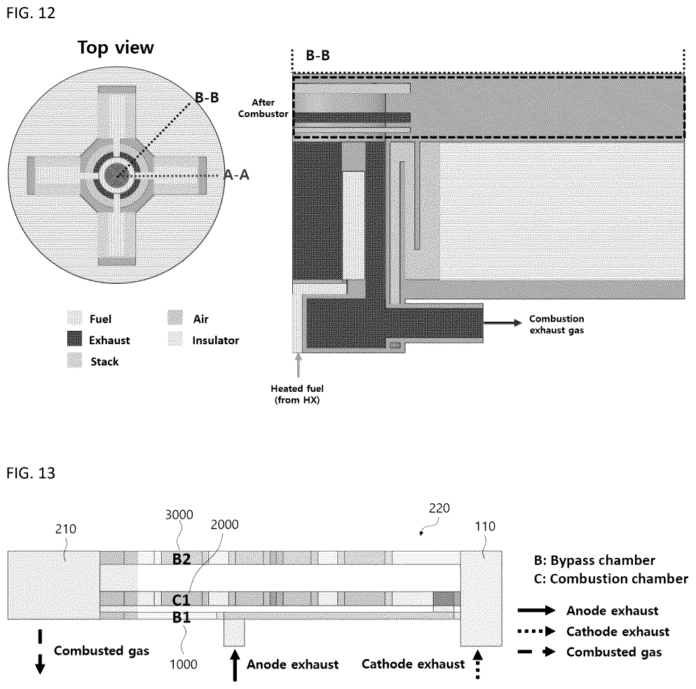

FIG. 10(a) shows an embodiment of the lower bypass chamber 1000 equipped with the transverse flow path 1100. FIGS. 10(b) and 10(c) show embodiments of the combustion chambers 2000 equipped with different internal inlets 2100. FIG. 10(d) is an embodiment of the upper bypass chamber 3000 equipped with the longitudinal flow path 3100.

While the anode exhaust gas moves transversely through the transverse flow path 1100 and then moves upward, part of the anode exhaust gas flows into the fuel chamber 2000 through the internal inlet 2100 and part of the anode exhaust gas moves upward through the closed longitudinal flow path 3100.

Accordingly, the anode exhaust gas is not introduced into the internal space of the upper bypass chamber 3000. Furthermore, the top side of the upper bypass chamber 3000 located in the upper part is closed with a cover or the like, and the top side of the longitudinal flow path 3100 is also closed.

The internal inlet 2100 of the combustion chamber 2000 according to the present invention may be provided with one or more partitions that prevent the introduced anode exhaust gas from moving directly in the direction of the second open end 220b.

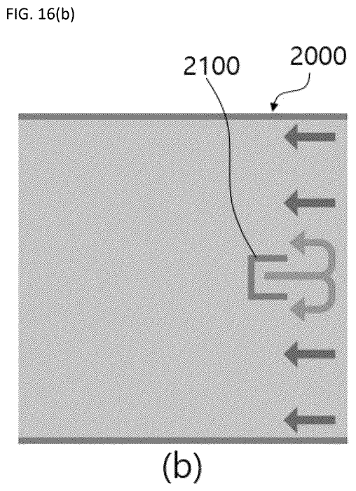

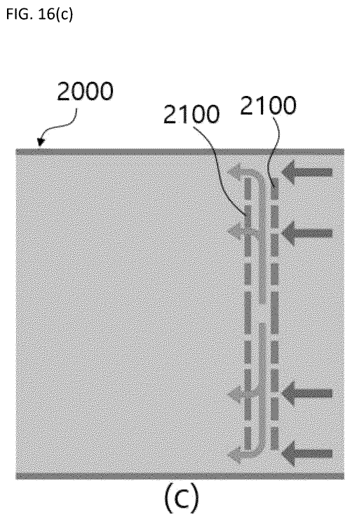

The embodiments of the internal inlet 2100 shown in FIGS. 10(b), 16(a), and 16(b) are embodiments in which introduced anode exhaust gas is first directed in the direction opposite to the direction of movement of the introduced anode exhaust gas and is then moved in the direction of movement again.

The embodiment of the internal inlet 2100 shown in FIG. 10c shows an embodiment in which introduced anode exhaust gas is directed in the direction traversing the direction of movement of the introduced anode exhaust gas and is then moved in the direction of movement through the space between partitions or the like.

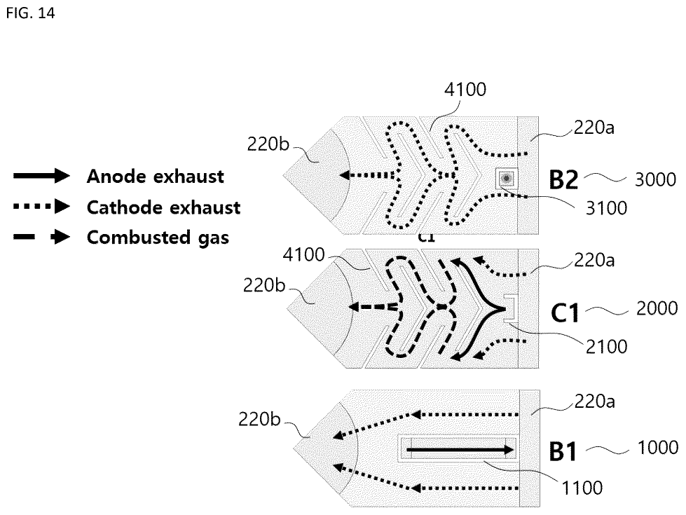

Meanwhile, as in the internal inlet 2100 shown in FIG. 14, it may also be possible to direct the introduced anode exhaust gas directly in the direction of movement. However, in this case, it is more preferable that a partition 4100 is provided on a flow path.

In the case of the bypass chamber, the main function thereof is to branch cathode exhaust gas and adjust the fuel/oxidizer ratio in the combustion chamber. As its additional function, the bypass chamber may also perform the role of lowering the maximum temperature by absorbing the heat generated in the combustion chamber.

The combustion chamber 2000 and the upper bypass chamber 3000 may each be provided with a flow control partition, including the partition 4100 configured to form a bent flow path, which may generate flow resistance and help to mix the fuel and oxidant introduced into the combustion chamber 2000.

In the bypass chamber, the cathode exhaust gas may be introduced from an end side and discharged to the center. Only the cathode exhaust gas is introduced into the bypass chamber, so that no chemical reaction occurs.

The combustion chamber functions to combust the fuel remaining in anode exhaust gas. The cathode exhaust gas may be introduced from an end side, and the anode exhaust gas may also be introduced from an end side. The anode exhaust gas and the cathode exhaust gas may be combusted in the combustion chamber and discharged to the center. The inlet of the combustion chamber 2000 for the cathode exhaust gas (air and an oxidant) may adopt a structure in which the cathode exhaust gas does not directly flow into the outlet, but is discharged after making a detour.

In the present invention, the amount of oxidant supplied to the combustion chamber may be controlled by using the lower bypass chamber 1000 and upper bypass chamber 3000 that are stacked and coupled in the lower and upper parts of the combustion chamber 2000.

Due to the characteristics of the fuel cell, when the anode exhaust gas and the cathode exhaust gas are mixed and combusted at the same time in the combustion chamber, the fuel becomes insufficient compared to the oxidant, resulting in lean combustion. The bypass chambers are located in the upper and lower parts of the combustion chamber, and internal flow paths inside the bypass chambers are installed with a baffle or lip structure so that they can generate lower flow resistance than the internal flow path of the combustion chamber. In this case, the cathode exhaust gas will be directed to the bypass chambers having lower flow resistance, which reduces the amount of oxidant in the combustion chamber and thus increases the equivalence ratio, thereby causing a combustion reaction to occur more actively.

In the present invention, the amount of anode exhaust gas (fuel) flowing into the combustion chamber may be controlled by adjusting the gas flow resistance of each chamber with the flow control partition unit.

The flow path control partition unit (to which a reference numeral is not assigned) according to the present invention refers to a comprehensive name including partitions 4110, partition pivot points 4110, lateral rotation shafts 4200, and vertical rotation shafts 4300.

In the present invention, the heat generated in the combustion chamber 2000 is absorbed by the upper and lower bypass chambers 1000 and 3000 that are stacked vertically, thereby preventing the excessive heating of the combustion chamber 2000.

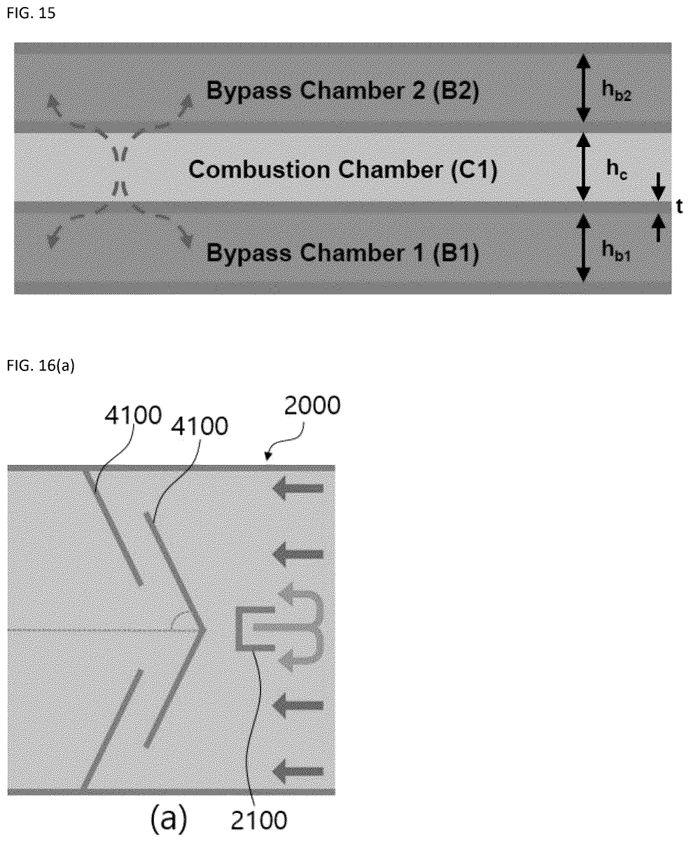

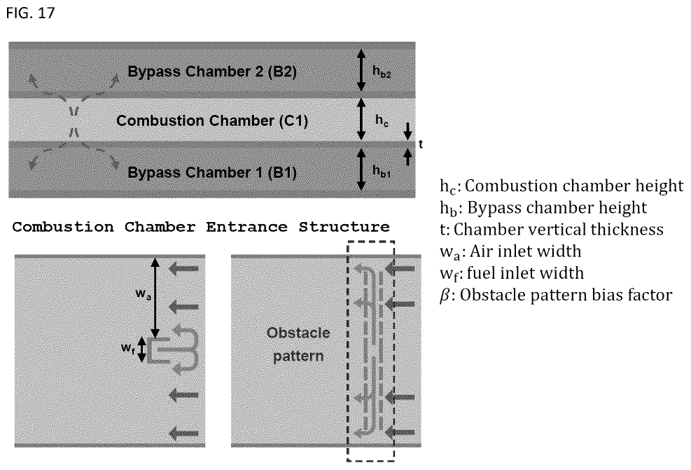

FIG. 15 is a conceptual diagram of an embodiment in which individual chambers are repeatedly stacked on and coupled to each other in an afterburner according to the present invention. FIG. 16 shows combustion chambers 2000. FIG. 16(a) shows a situation in which the flow resistance of the anode exhaust gas introduced through the anode exhaust gas internal inlet 2100 and the cathode exhaust gas introduced through the first open end are controlled by the partitions 4100. FIGS. 16(b) and 16(c) show other embodiments of the anode exhaust gas internal inlet 2100. FIG. 17 is a conceptual diagram showing controllable variables in FIG. 16. For reference, the component described as the “rib” in this drawing refers to the “partition 4100.”

h_{c,b} may determine the basic flow rate flowing into each chamber.

Wₐ/W_{f} may determine the basic amount of oxidant flowing into the combustion chamber.

β may determine the degree of spread of fuel in the entrance of the combustion chamber.

Each chamber may or may not be provided with flow path control partition units having various shapes such as bent flow paths, protrusions, etc. When the flow path control partition unit is provided, it may generate flow resistance and thus control the amount of cathode exhaust gas flowing into the combustion chamber, it may mix fuel and oxidant well in the combustion chamber and thus help the combustion reaction, and it may change the heat transfer coefficient depending on the arrangement of the flow path control partition unit.

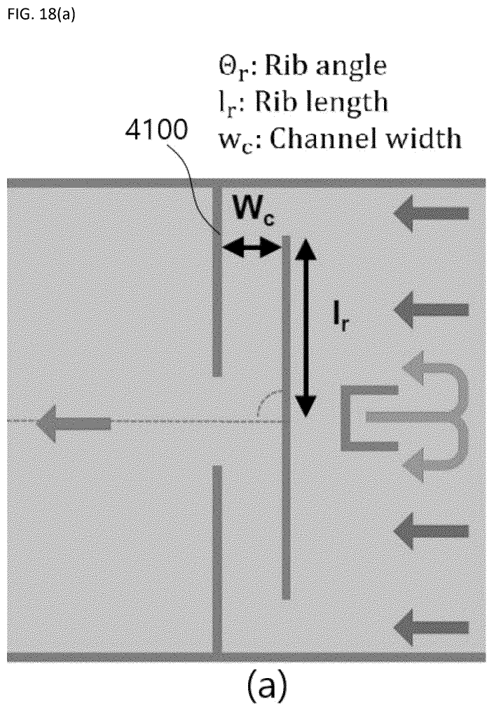

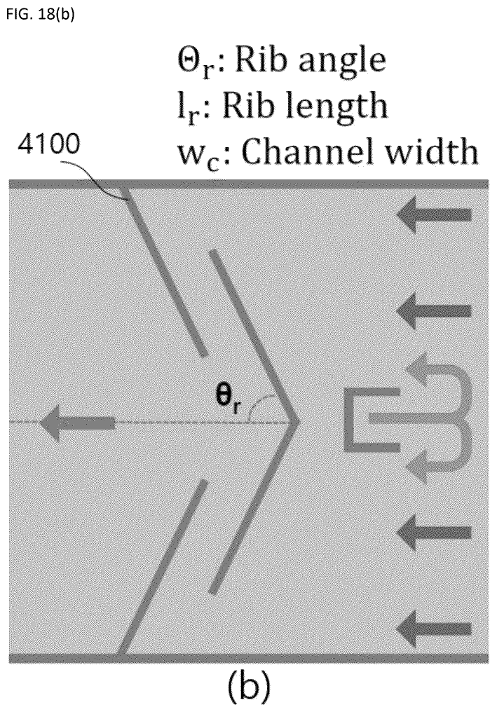

In the present invention, the flow path control partition unit may be provided in a structure in which a plurality of partitions 4100 spaced apart from each other are arranged vertically (see FIG. 18(a)) or obliquely (see FIG. 18(b)) to the direction in which introduced gas moves. The flow path and the flow rate may be changed and controlled by the vertical arrangement and the oblique arrangement.

In the present invention, it is preferable that the vertical or oblique arrangement structure of the plurality of partitions 4100 in the flow path control partition unit is configured such that a partition arrangement configured to branch each gas and a partition arrangement configured to merge individual gases are repeated. Through this repetition, the mixing of gases may be performed more smoothly.

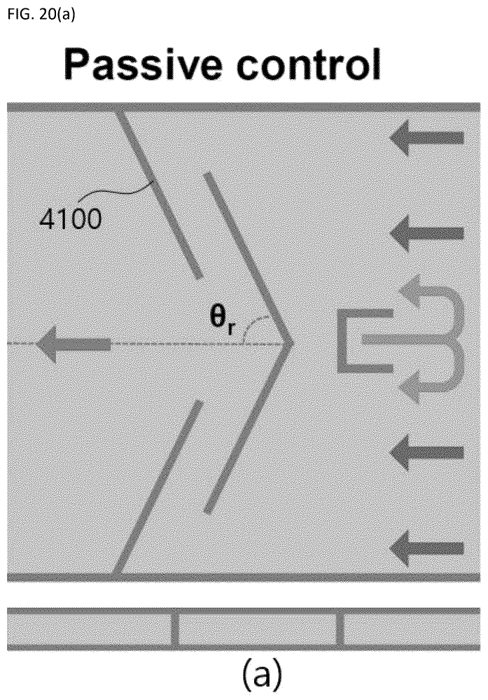

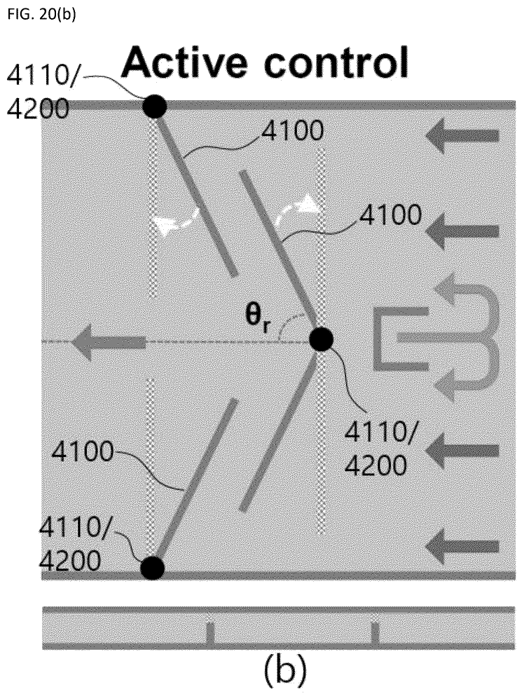

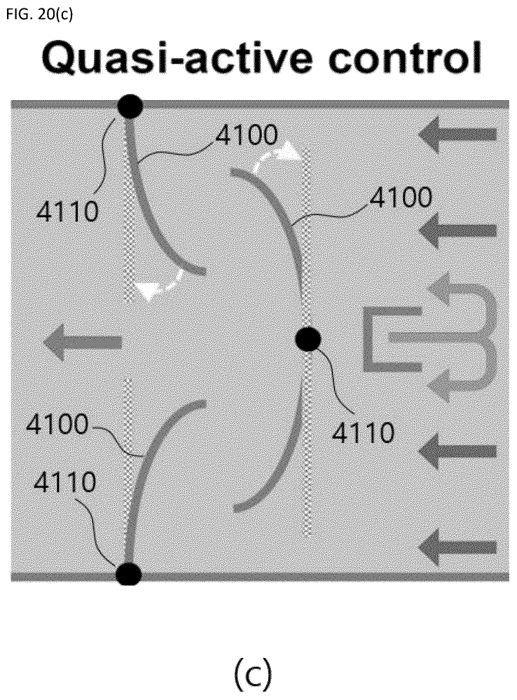

In the present invention, the flow path control partition unit may be provided as a fixed partition structure in which the partitions 4100 are fixedly arranged. FIG. 20(a) shows an embodiment in which the partitions 4100 are fixed.

In the present invention, the flow path control partition unit may have a laterally variable partition structure in which the partitions 4100 are provided to be rotatable laterally within a preset angular range and, thus, can control the space through which gas moves.

FIG. 20(b) shows an embodiment in which partitions 4100 are rotatable about the lateral rotation shafts 4200. As shown in FIG. 20(b), in the case of the laterally variable partition structure, the pivot points 4110 of the individual partitions 4100 of the individual chambers that are vertically stacked on top of each other are coupled to respective lateral rotation shafts 4200 that are arranged to vertically pass through the individual chambers, so that, when the lateral rotation shafts 4200 are rotated laterally, the individual partitions 4100 may also be rotated laterally. The rotation of the lateral rotation shafts 4200 may be implemented in various manners, such as manually or electrically, inside or outside the chambers.

In the case of the laterally variable partition structure, first, when the flow resistance needs to be increased, the partitions may be rotated to form a bent flow path, thereby increasing the length of the streamline. Second, the partitions may be rotated based on the pivot points. Third, rotation drive units (not shown) coupled to the pivot points may be rotated in conjunction with the pivot points inside or outside the chambers, thereby controlling the angles of the partitions. Fourth, when a stack structure is used, a plurality of pivot points that have the same planar locations of the lateral rotation shafts 4200 arranged to vertically pass through the individual chambers but are disposed in different layers may be connected to each other and rotated together.

In the present invention, there may be provided a bimetallic partition structure in which the partitions 4100 are made of a bimetallic material and, thus, can be bent laterally at a preset temperature. FIG. 20(c) shows an embodiment of the bimetallic partition structure in which the partitions 4100 are made of a bimetallic material and, thus, can be bent laterally based on the pivot points 4110 at the preset temperature.

In the bimetallic partition structure, partitions 4100 may be provided with respective pivot points 4110, as shown in FIG. 20(c). In the embodiment of FIG. 20(b), lateral rotation shafts 4200 at which pivot points 4110 are vertically connected to each other are provided, so that individual partitions 4110 connected to the respective pivot points 4110 can rotate at the same time. However, in the embodiment of FIG. 20(c), it is preferable that individual pivot points 4110 are not connected to each other in the vertical direction.

The partitions can be manufactured using bimetal so that the shapes of the partitions can be changed according to changes in temperature. When the combustion chamber is at a low temperature, the equivalence ratio may be increased by decreasing the air flow rate. When the combustion chamber is at a high temperature, the partitions may be made of bimetal so that the partitions are bent at a high temperature in order to decrease the equivalence ratio by increasing the air flow rate. This is a configuration that automatically changes the degree of bending of the partitions according to the internal environment by utilizing the physical properties of metal without external physical intervention.

In the present invention, the partitions may be made of bimetal so that the shapes of the partitions can be changed according to changes in temperature. The bimetal partitions may be designed to react according to the temperature inside the chamber in order to form an optimal internal environment (including the equivalence ratio, the maximum temperature, and the heat transfer coefficient). Since the fuel cell afterburner is in a lean combustion condition where fuel is lean and excessive air (an excessive oxidant) is supplied, the purpose of the fuel cell afterburner is to control the air flow rate by controlling the partitions through bimetal so that the equivalence ratio approaches 1. In the case of stack coupling, different bimetal materials may be used for individual layers and thus make the direction and degree of curvature of the bimetal different.

In one embodiment, the low temperature of the combustion chamber means that the equivalence ratio is low (<<1) and less combustion reaction occurs. When the temperature is low, the bimetallic partitions of the combustion chamber may be bent to increase the length of the streamline and reduce the amount of cathode exhaust gas flowing into the combustion chamber, thereby increasing the equivalence ratio. Furthermore, the bimetal of the bypass chamber may be relatively spread out to increase the air flowing into the bypass chambers and relatively reduce the air flowing into the combustion chambers, thereby increasing the equivalence ratio.

In another embodiment, the high temperature of the combustion chamber means that the equivalence ratio is high (>1) and the much combustion reaction occurs. When the temperature is high, the bimetallic partitions of the combustion chamber may be spread out to reduce the length of the streamline and increase the amount of cathode exhaust gas flowing into the combustion chamber, thereby reducing the equivalence ratio. Furthermore, the bimetal of the bypass chambers may be relatively bent to decrease the air flowing into the bypass chambers and relatively increase the air flowing into the combustion chamber, thereby increasing the equivalence ratio.

In the present invention, each of the partitions 4100 of the flow path control partition unit may include at least one of a closed partition in which the height hr of the partition 4100 is provided to be coupled to both the bottom and top surfaces of the internal space, and a partially open partition in which the height hr of the partition 4100 is coupled to the bottom surface of the internal space and separated from the top surface of the internal space, or is coupled to the bottom surface of the internal space and separated from the top surface of the internal space, so that gas can move through a space over or under the partition.

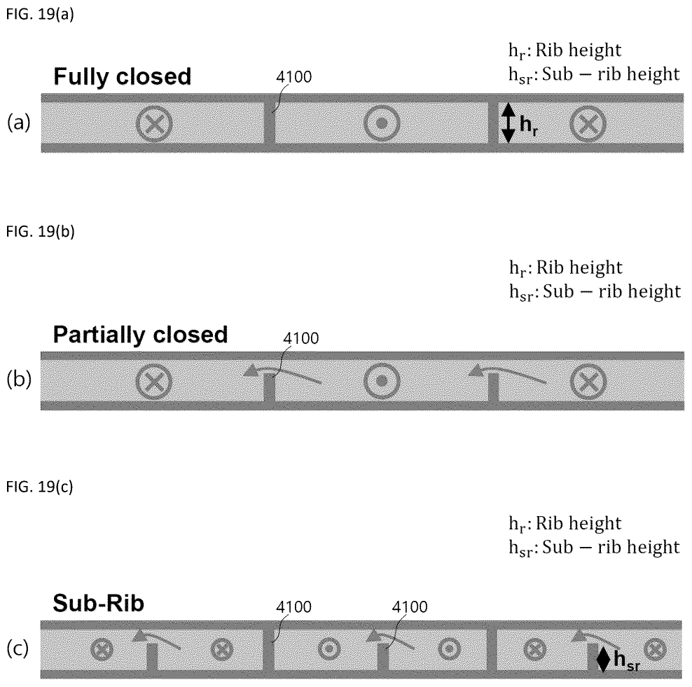

FIG. 19(a) shows an embodiment of the closed partition in which the height hr of the partition 4100 is provided to be coupled to both the bottom and top surfaces of the internal space. This embodiment is the most basic case in which a flow moves along the path formed by the partition, in which case the length of the streamline is longest.

FIG. 19(b) shows an embodiment of the partially open partition in which the height hr of the partition 4100 is provided to be coupled to the bottom surface of the internal space but is separated from the top surface of the internal space, so that gas can move over the partition. Since the partition is not completely closed, the gas does not flow along the flow path but sometimes passes over the partition, so that the streamline is shorter than that of the closed partition. Furthermore, a vortex is generated in the process of passing over the partition, so that the mixing effect and the heat transfer coefficient are increased.

FIG. 19(c) shows an embodiment in which closed partitions and partially open partitions are provided together and the partially open partitions are provided within the channels formed by the closed partitions.

Basically, the same path is formed as in the case of completely closed partitions, so that the length of the streamline is the same. However, vortex shapes generated in the partially open portions may be caused by using the partially open auxiliary partitions, thereby increasing the mixing effect and the heat transfer coefficient.

The purpose of applying the above-described various partition structures is to perform adjustment to prevent the temperature inside the afterburner from becoming excessively high by optimizing the heat exchange of the afterburner while maximizing the combustion of fuel in anode exhaust gas based on a driving environment.

In the present invention, in order to form the necessary flow resistance, a partition (4100) structure may be provided inside each chamber. When the width of the flow path is decreased and the length of the streamline is increased by the partitions, the flow resistance may increase. Partially open (and partially closed) partitions may change not only the flow resistance but also the heat transfer coefficient due to vortices.

In the case of FIG. 18, the flow resistance in a corresponding chamber may increase when We decreases and the flow resistance in the corresponding chamber may increase when lᵣ increases, so that this case may play a role in determining the amount of oxidant, such as reducing the amount of oxidant flowing into the corresponding chamber. Θᵣ may change the length of the streamline.

In the case of FIG. 19, hᵣ/h_{c,b} and hₛᵣ/h_{c,b} may change the flow resistance and the heat transfer coefficient.

In the present invention, the flow path control partition unit may has a vertically variable partition structure in which the partitions 4100 are provided to be rotatable vertically within a preset angular range and, thus, can control the space through which gas moves.

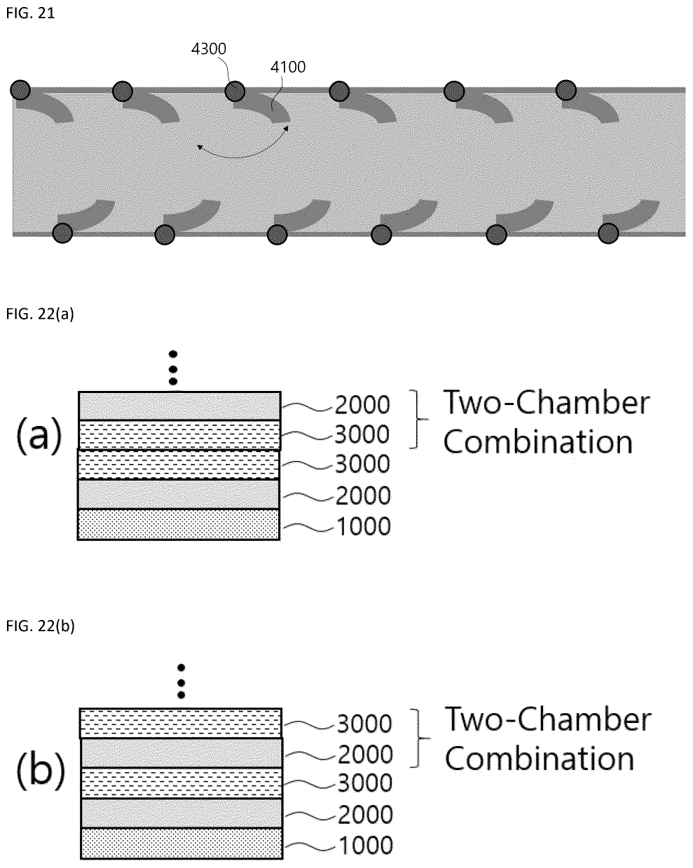

FIG. 21 shows an embodiment in which partitions 4100 are rotatable about vertical rotation shafts 4300. As shown in FIG. 21, the individual partitions 4100 in contact with the inner wall of each chamber are coupled to the vertical rotation shafts 4300 that are vertically arranged to laterally pass through the chamber from the outside of the chamber. Accordingly, when the vertical rotation shafts 4300 vertically rotated from the inside or outside of the chamber, the individual partitions 4100 may also be rotated vertically. The rotation of the vertical rotation shafts 4300 may be implemented in various manners, such as manually or electrically, inside or outside the chamber.

FIG. 21 shows a sectional view of an afterburner according to the present invention when viewed from the right side, which shows a state in which bimetallic partitions are bent upward due to a change in temperature. The space between the partitions is a space through which the working fluid flows. As the temperature changes, the bent bimetal may function to increase the heat transfer coefficient. When the temperature of the combustion chamber is high, the bimetallic partitions are bent upward, so that the heat exchange areas are increased, and thus the heat transfer coefficient is increased, with the resulting that more heat can be released/absorbed.

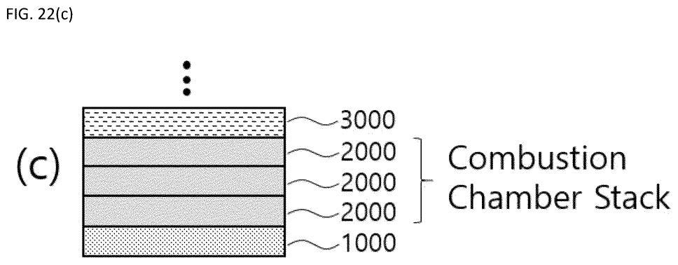

Meanwhile, in the present invention, the stack coupling of individual chambers may be implemented in various manners. FIGS. 22(a) to 22(c) show various embodiments of the repeated stack coupling of individual chambers according to the present invention.

As a first embodiment, there may be provided an embodiment in which two-chamber combinations of an upper bypass chamber 3000 and a combustion chamber 2000 are repeatedly stacked on top of the lower bypass chamber 1000, the combustion chamber 2000, and the upper bypass chamber 3000 sequentially stacked on top of each other (see FIG. 22(a)). As a second embodiment, there may be provided an embodiment in which two-chamber combinations of a combustion chamber 2000 and an upper bypass chamber 3000 are repeatedly stacked on top of the lower bypass chamber 1000, the combustion chamber 2000, and the upper bypass chamber 3000 sequentially stacked on top of each other (see FIG. 22(b)). As a third embodiment, there may be provided an embodiment in which an embodiment in which the lower bypass chamber 1000 is provided on the lowest side, the upper bypass chamber 3000 is provided on the highest side, and a plurality of combustion chambers 2000 are repeatedly stacked therebetween (see FIG. 22(c)). Alternatively, there may be provided an embodiment in which chamber combinations according to the third embodiment are repeatedly stacked on top of each other.

Meanwhile, the fuel cell hotbox according to the present invention may include the above-described afterburner. Since the technical configuration of the afterburner is the same as described above, the following description will be given with a focus on the main configuration thereof for ease of description, but it is apparent that all the above-described technical configurations of the afterburner may be applied to the fuel cell hotbox.

According to the present invention, there is provided a fuel cell hotbox, including: a housing 100 provided with a first internal space 110, a first inlet 120, a second inlet 130, and an outlet 140; a central chamber 200 located in the center of the first internal space 110, and provided with a second internal space 210, the afterburner 220, and a reformer 230; a plurality of fuel cell stack parts 300 located at equal distances from the center of the central chamber part 200 in the first internal space 110, and arranged at regular intervals therebetween; and an air-heat exchange part 400 provided between the plurality of fuel cell stack parts 300 and the central chamber part 200; wherein the afterburner 220 includes: the lower bypass chamber 1000 configured such that the cathode exhaust gas introduced from the first open end 220a flows out into the second open end 220b, and provided with the transverse flow path 1100 through which the anode exhaust gas introduced from one side is separated from the cathode exhaust gas and flows out into the combustion chamber 2000 coupled to the top side of the lower bypass chamber 1000; the combustion chamber 2000 coupled to the top side of the lower bypass chamber 1000, and configured such that the cathode exhaust gas introduced from the first open end 220a and the anode exhaust gas introduced through the internal inlet 2100 communicating with the transverse flow path 1100 of the lower bypass chamber 1000 are mixed and combusted and then moved to the second open end 220b; and the upper bypass chamber 3000 coupled to the top of the combustion chamber 2000, configured such that the cathode exhaust gas introduced from the first open end 220a flows out into the second open end 220b, and provided with the longitudinal flow path 3100 that is closed such that the anode exhaust gas moving upward from the internal inlet 2100 of the combustion chamber without entering the combustion chamber does not enter the internal space of the upper bypass chamber 3000; wherein at least one of the internal spaces of the lower bypass chamber 1000, the combustion chamber 2000, and the upper bypass chamber 3000 is provided with the flow path control partition unit in which the plurality of partitions 4100 are arranged to be spaced apart from each other.

The embodiments described herein and the accompanying drawings are merely illustrative examples of parts of the technical spirit included in the present invention. Therefore, the embodiments disclosed herein are not intended to limit the technical spirit of the present invention but are intended to describe them, so that it is obvious that the scope of the technical spirit of the present invention is not limited to these embodiments. All modifications and specific embodiments that can be easily inferred by a person skilled in the art within the scope of the technical spirit included in the present specification and the accompanying drawings should be interpreted as being included in the scope of the rights of the present invention.

What is claimed is:

1. A fuel cell afterburner having at least one flow path control partition unit inside stacked chambers, the fuel cell afterburner comprising:
a lower bypass chamber configured such that an cathode exhaust gas introduced from a first open end flows out into a second open end, and provided with a transverse flow path through which an anode exhaust gas introduced from one side is separated from the cathode exhaust gas and flows out into a combustion chamber coupled to a top side of the lower bypass chamber;
the combustion chamber coupled to a top side of the lower bypass chamber, and configured such that a cathode exhaust gas introduced from a first open end and an anode exhaust gas introduced through an internal inlet communicating with the transverse flow path of the lower bypass chamber are mixed and combusted and then moved to a second open end; and
an upper bypass chamber coupled to a top of the combustion chamber, configured such that an cathode exhaust gas introduced from a first open end flows out into a second open end, and provided with a longitudinal flow path that is closed such that an anode exhaust gas moving upward from the internal inlet of the combustion chamber without entering the combustion chamber does not enter an internal space of the upper bypass chamber;
wherein at least one of internal spaces of the lower bypass chamber, the combustion chamber, and the upper bypass chamber is provided with a flow path control partition unit in which a plurality of partitions are arranged to be spaced apart from each other.

2. The fuel cell afterburner of claim 1, wherein the internal inlet of the combustion chamber is provided with one or more partitions that prevent the introduced anode exhaust gas from moving directly in a direction of the second open end.

3. The fuel cell afterburner of claim 1, wherein an amount of anode exhaust gas flowing in into the combustion chamber is controlled by adjusting flow resistance of each of the chambers using the flow path control partition unit.

4. The fuel cell afterburner of claim 1, wherein excessive heating of the combustion chamber is prevented in such a manner that the lower and upper bypass chambers absorb heat generated in the combustion chamber.

5. The fuel cell afterburner of claim 1, wherein the flow path control partition unit is provided in a structure in which the plurality of partitions spaced apart from each other are arranged vertically or obliquely to a direction in which the introduced gas moves.

6. The fuel cell afterburner of claim 5, wherein the vertical or oblique arrangement structure of the plurality of partitions in the flow path control partition unit is configured such that a partition arrangement configured to branch each gas and a partition arrangement configured to merge individual gases are repeated.

7. The fuel cell afterburner of claim 1, wherein the flow path control partition unit has a fixed partition structure in which the plurality of partitions are fixedly arranged.

8. The fuel cell afterburner of claim 1, wherein the flow path control partition unit has a laterally variable partition structure in which the plurality of partitions are provided to be rotatable laterally within a preset angular range and, thus, can control a space through which gas moves.

9. The fuel cell afterburner of claim 8, wherein pivot points of individual partitions of the individual chambers that are vertically stacked on top of each other are coupled to respective lateral rotation shafts that are arranged to vertically pass through the individual chambers,
so that, when the lateral rotation shafts are rotated laterally, the individual partitions are also rotated laterally.

10. The fuel cell afterburner of claim 1, wherein the flow path control partition unit has a bimetallic partition structure in which the plurality of partitions are made of a bimetallic material and, thus, can be bent laterally at a preset temperature.

11. The fuel cell afterburner of claim 1, wherein each of the plurality of partitions of the flow path control partition unit comprises at least one of:
a closed partition in which a height of the partition is provided to be coupled to both bottom and top surfaces of the internal space; and
a partially open partition in which a height of the partition is coupled to a bottom surface of the internal space and separated from a top surface of the internal space, or is coupled to the bottom surface of the internal space and separated from the top surface of the internal space, so that gas can move through a space over or under the partition.

12. The fuel cell afterburner of claim 1, wherein the flow path control partition unit has a vertically variable partition structure in which the plurality of partitions are provided to be rotatable vertically within a preset angular range and, thus, can control a space through which gas moves.

13. The fuel cell afterburner of claim 12, wherein the individual partitions in contact with an inner wall of each of the chambers are coupled to vertical rotation shafts that are vertically arranged to laterally pass through the chamber from an outside of the chamber, so that, when the vertical rotation shafts are vertically rotated from an inside or outside of the chamber, the individual partitions are also rotated vertically.

14. The fuel cell afterburner of claim 1, wherein two-chamber combinations of a combustion chamber and an upper bypass chamber are repeatedly stacked on top of the lower bypass chamber, the combustion chamber, and the upper bypass chamber sequentially stacked on top of each other.

15. The fuel cell afterburner of claim 1, wherein two-chamber combinations of a combustion chamber and an upper bypass chamber are repeatedly stacked on top of the lower bypass chamber, the combustion chamber, and the upper bypass chamber sequentially stacked on top of each other.

16. The fuel cell afterburner of claim 1, wherein the lower bypass chamber is provided on a lowest side, the upper bypass chamber is provided on a highest side, and a plurality of combustion chambers are repeatedly stacked therebetween.

17. A fuel cell hotbox, comprising:
a housing provided with a first internal space, a first inlet, a second inlet, and an outlet;
a central chamber part located in a center of the first internal space, and provided with a second internal space, an afterburner, and a reformer;
a plurality of fuel cell stack parts located at equal distances from a center of the central chamber part in the first internal space, and arranged at regular intervals therebetween; and
an air-heat exchange part provided between the plurality of fuel cell stack parts and the central chamber part;
wherein the afterburner comprises:
a lower bypass chamber configured such that an cathode exhaust gas introduced from a first open end flows out into a second open end, and provided with a transverse flow path through which an anode exhaust gas introduced from one side is separated from the cathode exhaust gas and flows out into a combustion chamber coupled to a top side of the lower bypass chamber;
the combustion chamber coupled to a top side of the lower bypass chamber, and configured such that a cathode exhaust gas introduced from a first open end and an anode exhaust gas introduced through an internal inlet communicating with the transverse flow path of the lower bypass chamber are mixed and combusted and then moved to a second open end; and
an upper bypass chamber coupled to a top of the combustion chamber, configured such that an cathode exhaust gas introduced from a first open end flows out into a second open end, and provided with a longitudinal flow path that is closed such that an anode exhaust gas moving upward from the internal inlet of the combustion chamber without entering the combustion chamber does not enter an internal space of the upper bypass chamber;
wherein at least one of internal spaces of the lower bypass chamber, the combustion chamber, and the upper bypass chamber is provided with a flow path control partition unit in which a plurality of partitions are arranged to be spaced apart from each other.
